(19) United States
(12) Patent Application Publication
(10) Pub. No.: US 2023/0102789 A1
(43) Pub. Date: Mar. 30, 2023

(54) RECOMMENDING ITEMS FOR PURCHASE TO A USER OF AN ONLINE CONCIERGE SYSTEM BASED ON AN EMOTION OF THE USER

(71) Applicant: Maplebear Inc. (dba Instacart), San Francisco, CA (US)

(72) Inventors: Leho Nigul, Aurora (CA); Shaun Maharaj, Vaughan (CA)

(21) Appl. No.: 17/488,291

(22) Filed: Sep. 28, 2021

(51) Int. Cl. G06Q 30/06; G06Q 30/02; G06F 16/2457; G06F 16/22; G06Q 10/06

(52) U.S. Cl. CPC G06Q 30/0631; G06Q 30/0635; G06Q 30/0201; G06F 16/24575; G06F 16/22; G06Q 10/06315

(57) ABSTRACT

An online concierge system determines an emotion of a user from inputs received from the user and other contextual information about a user to select items to identify to the user for an order. The online concierge system logs historical data about items included in orders by the user and corresponding emotions of the user and contextual information for the user when the items were included in orders. Subsequently, when the user requests to create an order, the online concierge system determines an emotion for the user and contextual information for the user and selects one or more items included in prior orders when the user had the same emotion and had similar contextual information. The online concierge system transmits information describing one or more of the selected items to a client device of the user for presentation.

### BACKGROUND

This disclosure relates generally to displaying items offered by a warehouse through an interface generated by an online concierge system, and more specifically to determining an order in which items offered by the warehouse are displayed that accounts for predicted availabilities of the items at the warehouse.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

Additionally, interactions by users with various client devices allow a client device or a server to infer a user's emotion from the one or more interactions. For example, a server determines a user's emotion by analyzing a voice input received from the user. As another example, the server determines the user's emotion from videos or images of a user's face received as input from the user. While this allows a server or client device to infer the user's emotion, conventional severs or client devices make limited use of such inference of emotion. As users often interact with client devices to place orders through an online concierge system, inputs from which a client device or a server infers the user's emotional state may be used to create an order or to otherwise request information from an online concierge system. However, conventional client devices and online concierge systems are unable to account for influence of a user's emotion on the user's actions, such as purchases made by the user.

### SUMMARY

An online concierge system receives orders from a user, with each order identifying a warehouse and including one or more items to obtain from the warehouse. The user provides various inputs to a client device to generate the order, and the client device transmits selections of items, search queries, or other information to the online concierge system. In various embodiments, the client device transmits inputs received from the user to the online concierge system, which determines an emotion of the user from the inputs. For example, the online concierge system applies one or more models to audio input (e.g., speech or other voice input) received from the user that determine an inferred emotion of the user from the audio input. In another example, the online concierge system applies one or more models to video input received from the client device to determine an inferred emotion of the user from the video input. In other examples, the online concierge system receives text input from the user and applies one or more models to the text input to infer an emotion of the user from the received text input.

In various embodiments, the online concierge system determines multiple emotions associated with the user for an order based on inputs received along with the order. For example, the online concierge system maintains a set of emotions, and application of one or more models to inputs received along with the order outputs a probability for each emotion of the set for the user. The online concierge system stores an embedding or vector including the probability output for each emotion of the set, allowing the online concierge system to account for multiple emotions of the user.

In some embodiments, the online concierge system also receives additional contextual information from the client device an order is received from the user. Example contextual information received includes health information of the user obtained from one or more sensors of the client device. Health information includes heart rate, oxygen levels, blood sugar levels, temperature, biometric information of the user, or any other suitable information describing a physical condition of the user. Additionally or alternatively, contextual information includes a location of the user when the order is received from the user. In some embodiments, the online concierge system determines the location of the user as a delivery location specified by the order, while the online concierge system may determine the location of the user as a location of the client device from which the order was received 505, using the location of the client device as a proxy for the location of the user.

The online concierge system stores the determined emotion of the user in association with the order received from the user when the emotion was determined and in association with the user. When the online concierge system receives contextual information along with the order, the online concierge system stores the contextual information in association with the order and the determined emotion of the user, allowing the online concierge system to maintain a record of contextual information of the user and determined emotion of the user for different orders received from the user. From items included in orders received from the user and determined emotions corresponding to the received orders, as well as contextual information received with the orders, the online concierge system generates an index correlating items included in orders with determined emotions of the user. For example, the online concierge system identifies an emotion and stores associations between the identified emotion and items included in orders that are associated with the identified emotion. In some embodiments, the online concierge system accounts for frequencies or rates with which items were included in orders associated with the identified emotion when generating the index. For example, the online concierge system stores associations between the identified emotion and items that were included in at least a threshold percentage of orders associated with the identified emotion in the index or stores associations between the identified emotion and items that were included in at least a threshold number of orders associated with the identified emotion. The online concierge system generates the index from orders received within a specific time interval in some embodiments. Additionally, the index accounts for contextual information received along with orders when generating the index. For example, the index associates combinations of an emotion and contextual information (or a range of contextual information) with items included in orders for which the combination of the emotion and the contextual information (or contextual information in a range of contextual information) were received. Generation of the index may account for frequencies with which items were included in orders associated with an emotion and with contextual information, as further described above. Hence, the index is generated for the user and identifies relationships between emotions of the user and items included in orders received from the user, allowing the index to provide a measure of how the user's emotion affects items that the user orders, as well as how combinations of contextual information and emotion affects items that the user orders. The online concierge system stores the index in association with the user.

The online concierge system stores a score in the index association with a combination of an item and an emotion in various embodiments, with the score providing a measure of relationship between the item and the emotion. In various embodiments, the score for a combination of an item and an emotion is based on a number of received orders including the item for which the online concierge system determined the emotion for the user. For example, a score associated with a combination of item and emotion is a percentage of orders associated with the emotion received from the user that include the item. In other examples, the score associated with the combination of item and emotion is generated from the percentage of orders associated with the emotion determined for the user that include the item. When the online concierge system stores contextual information with a received order as well as a determined emotion for the received order, the index associates a combination of the contextual information and the determined emotion in association with an item. In various embodiments, the online concierge system determines a score for an item and a combination of an emotion and contextual information from a number of received orders including the item for which the online concierge system determined the emotion for the user and received the contextual information. For example, a score associated with an item and a combination of emotion and contextual information is based on a percentage of orders that include the item and that are associated with the emotion determined for the user and with the contextual information. Hence, in various embodiments, the score for a combination of an item and an emotion reflects a rate at which the item was included in orders by the user when the emotion was determined for the user.

Subsequently, when the online concierge system receives a request for an additional order from the user, the online concierge system determines an emotion of the user when the request was received from inputs received in conjunction with the request, as further described above. In various embodiments, the online concierge system also receives contextual information about the user in conjunction with the request. From the emotion of the user when the request was received, and contextual information received along with the request, the online concierge system identifies candidate items for the user from the index stored in association with the user. The candidate items are items associated with the emotion of the user when the request was received, or associated with a combination of the emotion of the user when the request was received and the contextual information received in conjunction with the request, in the index. This allows the online concierge system to leverage the emotion determined for the user when the request for the additional order was received, as well as contextual information received in conjunction with the user, to identify candidate items for the user.

The online concierge system selects one or more of the candidate items for display to the user. For example, the online concierge system ranks the candidate items based on their corresponding scores in the index and selects one or more candidate items having at least a threshold position in the ranking for display. Such ranking allows the online concierge system to select candidate items the user has most frequently included in orders when the emotion was determined for the user, as the score for a combination of an item and an emotion is based on a frequency with which the item was included in orders received when the emotion was determined for the user. Alternatively, the online concierge system selects candidate items having at least a threshold score or selects a candidate item having a maximum score for the combination of candidate item and the emotion determined for the user when the request was received.

When selecting one or more items for display to the user, the online concierge system accounts for predicted availabilities of various candidate items at a warehouse identified by the request for an order. In various embodiments, the online concierge system applies a machine-learned availability model to each combination of the warehouse and a candidate item. The online concierge system selects one or more candidate items based on their scores for the emotion determined for the user when the request was received and the predicted availability of different candidate items. For example, the online concierge system ranks the candidate items based on their corresponding scores in the index and modifies the ranking by removing candidate items having less than a threshold availability. The online concierge system selects one or more candidate items having at least a threshold position in the modified ranking. In other embodiments, the online concierge system selects one or more candidate items having at least a threshold score and having at least a threshold predicted availability.

In some embodiments, the online concierge system selects one or more candidate items based on scores of the candidate items for the emotion determined for the user when the request was received and contextual information received in conjunction with the request for the additional order. For example, contextual information identifies a location for the additional order, and the online concierge system retrieves previously received orders identifying the location. From the previously received orders, the online concierge system ranks items based on frequencies with which the items occur in the previously received orders identifying the location. The online concierge system selects one or more items included in previously received orders identifying the location and associated with the emotion determined for the user when the request for the additional order was received. For example, the online concierge system selects items associated with the emotion determined for the user when the request was received having at least a threshold score for the emotion determined for the user when the request was received and included in previously received orders identifying the location.

As another example, the contextual information received in conjunction with the request for the additional order includes biometric information for the user. As further described above, the online concierge system identifies candidate items for the user from the index stored in association with the user. Each of the candidate items is associated with the emotion of the user when the request was received. The online concierge system retrieves attributes of the candidate items from an item catalog or other source of stored attributes for items offered by the warehouse and selects one or more items of the candidate items by comparing one or more attributes of the items to the biometric information for the user. For example, the online concierge system ranks candidate items by an attribute corresponding to the received biometric information for the user and compares the received biometric information to one or more threshold values. Based on the comparison of the biometric information for the user, the online concierge system determines a position in the ranking from which an item is selected. As an example, the biometric information received in conjunction with the request for the additional order includes the user's blood sugar level, so the online concierge system ranks candidate items based on their respective amounts of sugar. The online concierge system compares the user's blood sugar level to a threshold and selects an item from a range of positions in the ranking in response to the user's blood sugar level equaling or exceeding the threshold and selects an item from an alternative range of positions in the ranking in response to the user's blood sugar level being less than the threshold. This allows the online concierge system to leverage both the determined emotion for the user, as well as biometric information received for the user and attributes of items, to select one or more items for display to the user, while accounting for both items the user has previously purchased having the determined emotion and potential effects of those previously purchased items on biometric information received for the user.

The online concierge system transmits information identifying the one or more selected items to a client device (e.g., a mobile device, a desktop computer, a laptop computer, etc.) for display. In various embodiments, information identifying one or more selected items are displayed in a region of a customer mobile application. The information identifying one or more selected items are displayed in a region of the customer mobile interface identifying items previously purchased by the user. Additionally, the interface displays a selection element in conjunction with information identifying each selected item that includes the selected item in the additional order when selected by the user.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart illustrating a process for predicting inventory availability, according to one embodiment.

FIG. 5 is a flowchart of a method for method for an online concierge system to recommend one or more items to a user based in part on an emotion inferred for the user, according to one embodiment.

FIG. 6 is a process flow diagram of a method for method for an online concierge system to recommend one or more items to a user based in part on an emotion inferred for the user, according to one embodiment.

The Figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

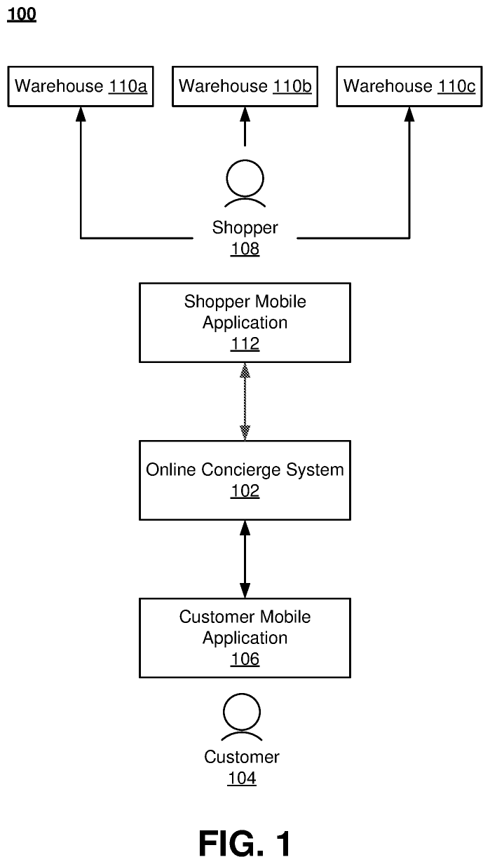

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

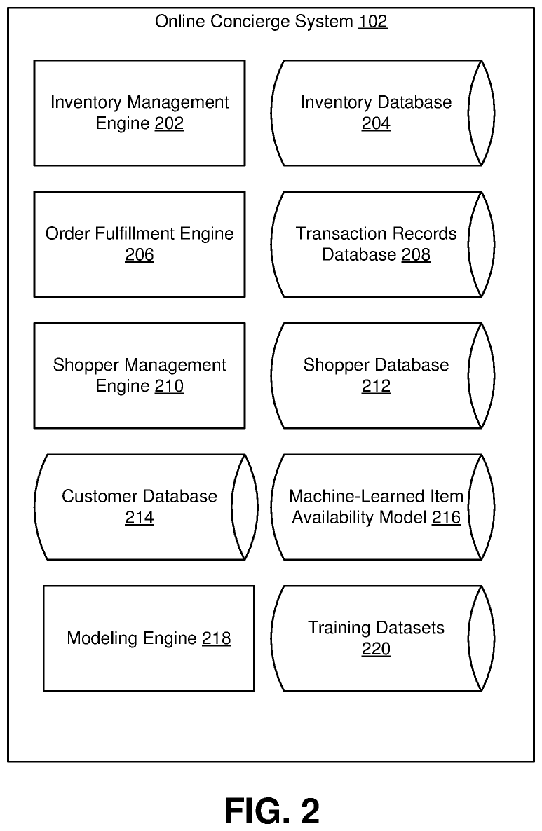

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. Different levels in the taxonomy providing different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

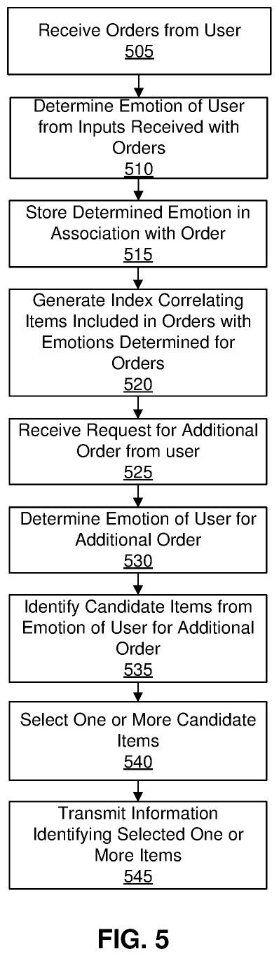

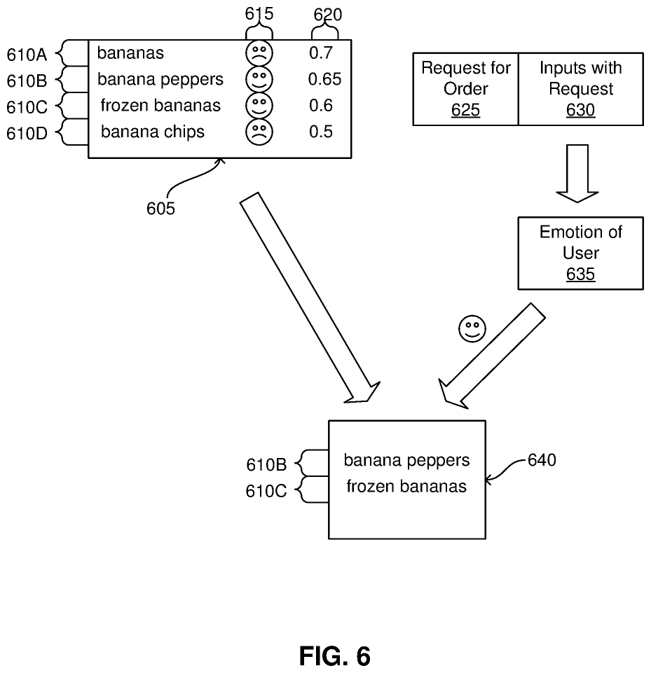

In various embodiments, the order fulfillment engine 206 leverages information describing emotions of users when the order fulfillment engine 206 previously received orders from the user to select one or more items to recommend to the user for inclusion in an order. As further described below in conjunction with FIGS. 5 and 6, when the order fulfillment engine 206 receives an order from the user, the order fulfillment engine 206 receives an emotion of the user determined by the modeling engine 218 from inputs received by the online concierge system 102 when generating the order. The order fulfillment engine 206 stores the emotion in association with the order, and stores contextual information received from the user in conjunction with the order. From items included in previously received orders and emotions for the user associated with the previously received orders, the order fulfillment engine 206 generates an index for the user that associates items with one or more emotions determined for the user when the user included items in orders. The index associates contextual information received along with orders in which an item was included with the item and the emotion determined for the user in various embodiments. The order fulfillment engine 206 stores the index in association with the user to maintain information describing relationships between emotions of the user and items the user included in orders.

When the order fulfillment engine 206 receives a request for an order from the user, the order fulfillment engine also receives an emotion of the user when the request was received. From the index stored in association with the user and the emotion of the user, the order fulfillment engine 206 identifies candidate items for recommending to the user and selects one or more of the candidate items for display to the user, as further described below in conjunction with FIG. 5. For example, candidate items are items that are associated with the emotion of the user when the request was received in the index stored for the user. When selecting one or more candidate items to recommend to the user, the order fulfillment engine 206 accounts for contextual information received along with the request for the order in various embodiments, as further described below in conjunction with FIG. 5.

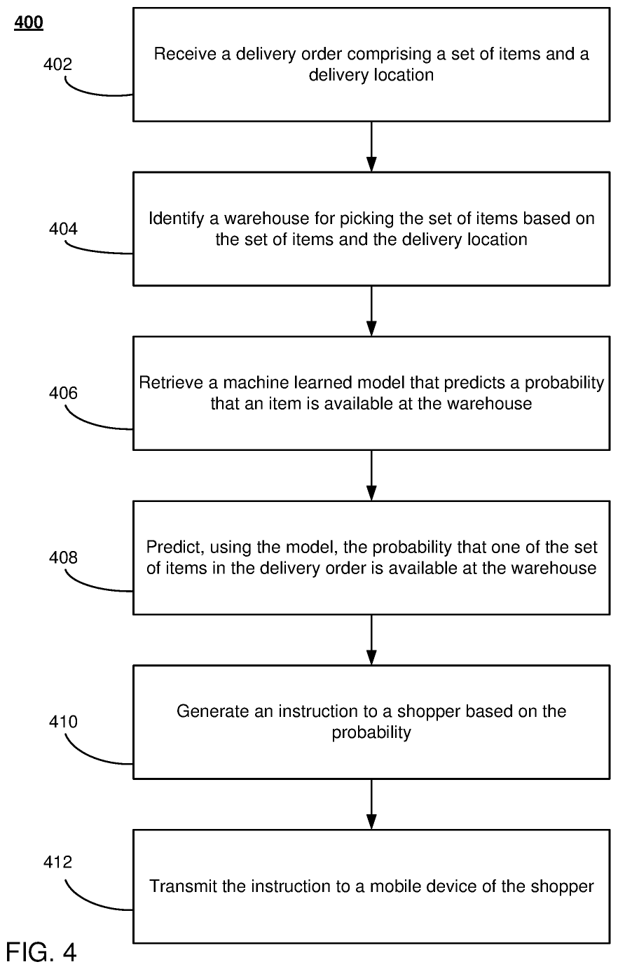

In some embodiments, the order fulfillment engine 206 generates one or more recommendations to a user from whom an order is received based on items included in the order. As further described below in conjunction with FIGS. 4 and 5, the order fulfillment engine 206 generates an order vector for a received order based on items included in the order, so different dimensions of the order correspond to different items included in the order. The order fulfillment engine 206 determines similarities between the order vector and recipe vectors corresponding to recipes obtained by the online concierge system 102. Recipe vectors are further described below in conjunction with FIG. 4. A similarity between the order vector and the recipe vector is based on an amount of items included in both the order vector and the recipe vector; hence, the similarity provides a measure of overlap between items in the order and items in the recipe corresponding to the recipe vector. Based on the similarities, the order fulfillment engine 206 selects one or more recipes and transmits a notification identifying a selected recipe to a client device for display to the user, as further described below in conjunction with FIGS. 4 and 5.

### Machine Learning Model

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110, also referred to as a predicted availability of the item at the warehouse 110. The machine-learned item availability model 216 may be used to predict item availability for items being displayed to or selected by a customer or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the customer 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 includes one or more models that, when applied to input received from a user, determine an emotion for the user from the input. Input received from a user may be audio data or video data received from a client device of the user. A model included in the modeling engine 218 is applied to a set of features of the input and an emotion of a set and outputs a probability of the emotion applying to the input. In various embodiments, the modeling engine 218 applies the model to different combinations of the input and an emotion of the set. The modeling engine 218 associates an emotion for which the model determined a maximum probability with the input in some embodiments, while in other embodiments, the modeling engine associates a vector of probabilities determined for different emotions of the set with the input. The model may be trained using any suitable technique from audio data, video data, text data, or any combination thereof, and may be retrained over time.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others, or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability, and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

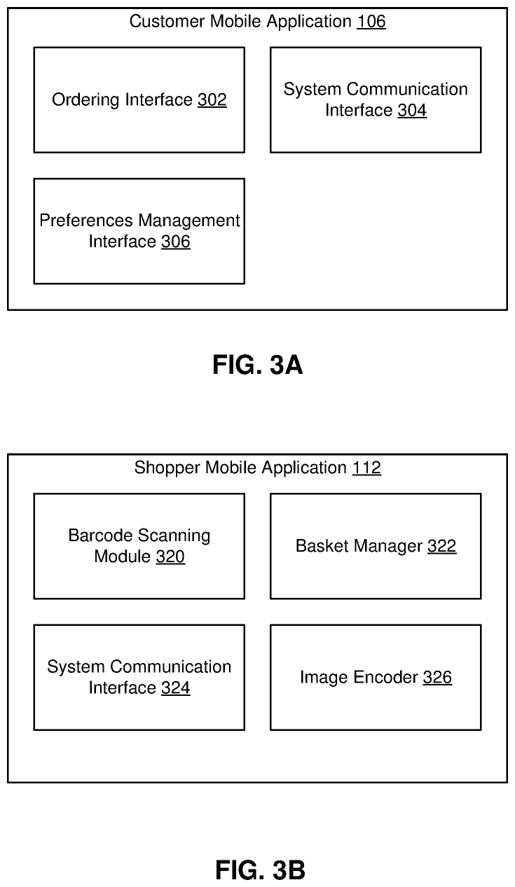

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Predicting Inventory Availability

As described with reference to FIG. 2, the machine-learned item availability model 216 of the online concierge system 102 can determine an availability of an item requested by the user 104. FIG. 4 is a flowchart illustrating a process 400 for predicting inventory availability, according to one embodiment. The online concierge system 102 receives 402 a delivery order that includes a set of items and a delivery location. The delivery location may be any location associated with a user, such as a user's home or office. The delivery location may be stored with the user location in the user database 214. Based on the delivery order, the online concierge system 102 identifies a warehouse 404 for picking the set of items in the delivery order based on the set of items and the delivery location. In some cases, the user specifies a particular warehouse or set of warehouses (e.g., a particular grocery store or chain of grocery stores) in the order. In other cases, the online concierge system 102 selects the warehouse based on the items and the delivery location. In some examples, there are a number of different possible warehouses that the set of items may be picked from. The warehouses may be identified by the order fulfillment engine 206 based on warehouses stored by the inventory management engine 202, and warehouses are identified with a suitable inventory and within a threshold distance of the delivery address. In some embodiments, a single delivery order can be split into multiple orders and picked at multiple warehouses, e.g., if the items cannot be fulfilled at a single warehouse. In this example, each possible warehouse is input into the machine-learned item availability model 216.

After the warehouses are identified, the online concierge system 102 retrieves 406 the machine-learned item availability model 216 that predicts a probability that an item is available at the warehouse. The items in the delivery order and the identified warehouses are input into the machine-learned item availability model 216. For example, the online concierge system 102 may input the item, warehouse, and timing characteristics for each item-warehouse pair into the machine-learned item availability model 216 to assess the availability of each item in the delivery order at each potential warehouse at a particular day and/or time. The machine-learned item availability model 216 predicts 408 the probability that one of the set of items in the delivery order is available at the warehouse. If a number of different warehouses are identified 404, then the machine-learned item availability model 216 predicts the item availability for each one. In some examples, the probability that an item is available includes a probability confidence score generated by the machine-learned item availability model 216.

The order fulfillment engine 206 uses the probability to generate 410 an instruction to a shopper. The order fulfillment engine 206 transmits the instruction to the shopper through the SMA 112 via the shopper management engine 210. The instruction is based on the predicted probability. In some examples, the shopper management engine 210 instructs the shopper to pick an item in the delivery order at a warehouse with the highest item availability score. For example, if a warehouse is more likely to have more items in the delivery order available than another warehouse, then the shopper management engine 210 instructs the shopper to pick the item at the warehouse with better availability. In some other examples, the order fulfillment engine 206 sends a message and/or instruction to a user based on the probability predicted by the machine-learned item availability model 216.

### Recommending Items to a User Based on an Emotion of the User

FIG. 5 is a flowchart of one embodiment of a method for an online concierge system 102 to recommend one or more items to a user based in part on an emotion inferred for the user. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

The online concierge system 102 receives 505 orders from a user, with each order identifying a warehouse 110 and including one or more items to obtain from the warehouse 110. The user provides various inputs to a client device to generate the order, and the client device transmits selections of items, search queries, or other information to the online concierge system 102. In various embodiments, the client device transmits inputs received from the user to the online concierge system 102, which determines 510 an emotion of the user from the inputs. For example, the online concierge system 102 applies one or more models to audio input (e.g., speech or other voice input) received from the user that determine an inferred emotion of the user from the audio input. In another example, the online concierge system 102 applies one or more models to video input received from the client device to determine an inferred emotion of the user from the video input. In other examples, the online concierge system 102 receives text input from the user and applies one or more models to the text input to infer an emotion of the user from the received text input.

In various embodiments, the online concierge system 102 determines 510 multiple emotions associated with the user for an order based on inputs received along with the order. For example, the online concierge system 102 maintains a set of emotions, and application of one or more models to inputs received along with the order outputs a probability for each emotion of the set for the user. The online concierge system 102 stores an embedding or vector including the probability output for each emotion of the set, allowing the online concierge system 102 to account for multiple emotions of the user.

In some embodiments, the online concierge system 102 also receives additional contextual information from the client device an order is received 505 from the user. Example contextual information received includes health information of the user obtained from one or more sensors of the client device. Health information includes heart rate, oxygen levels, blood sugar levels, temperature, biometric information of the user, or any other suitable information describing a physical condition of the user. Additionally or alternatively, contextual information includes a location of the user when the order is received 505 from the user. In some embodiments, the online concierge system 102 determines the location of the user as a delivery location specified by the order, while the online concierge system 102 may determine the location of the user as a location of the client device from which the order was received 505, using the location of the client device as a proxy for the location of the user.

The online concierge system 102 stores 515 the determined emotion of the user in association with the order received 505 from the user when the emotion was determined 510 and in association with the user. When the online concierge system 102 receives contextual information along with the order, the online concierge system 102 stores 515 the contextual information in association with the order and the determined emotion of the user, allowing the online concierge system 102 to maintain a record of contextual information of the user and determined emotion of the user for different orders received 505 from the user. From items included in orders received 505 from the user and determined emotions corresponding to the received orders, as well as contextual information received with the orders, the online concierge system 102 generates 520 an index correlating items included in orders with determined emotions of the user. For example, the online concierge system 102 identifies an emotion and stores associations between the identified emotion and items included in orders that are associated with the identified emotion. In some embodiments, the online concierge system 102 accounts for frequencies or rates with which items were included in orders associated with the identified emotion when generating 520 the index. For example, the online concierge system 102 stores associations between the identified emotion and items that were included in at least a threshold percentage of orders associated with the identified emotion in the index or stores associations between the identified emotion and items that were included in at least a threshold number of orders associated with the identified emotion. The online concierge system 102 generates 520 the index from orders received within a specific time interval in some embodiments. Additionally, the index accounts for contextual information received along with orders when generating 520 the index. For example, the index associates combinations of an emotion and contextual information (or a range of contextual information) with items included in orders for which the combination of the emotion and the contextual information (or contextual information in a range of contextual information) were received. Generation of the index may account for frequencies with which items were included in orders associated with an emotion and with contextual information, as further described above. Hence, the index is generated 520 for the user and identifies relationships between emotions of the user and items included in orders received 505 from the user, allowing the index to provide a measure of how the user's emotion affects items that the user orders, as well as how combinations of contextual information and emotion affects items that the user orders. The online concierge system 102 stores the index in association with the user.

In embodiments, where the online concierge system 102 determines 510 multiple emotions associated with the user for an order based on inputs received along with the order, the online concierge system 102 stores correlations between the order and each of the determined emotions. For example, when generating 520 the index, the online concierge system 102 stores a correlation between an order and each emotion determined 510 for the user from inputs corresponding to the user. As another example, the index stores an association between and order and an embedding or vector including a determined probability for each emotion of a set determined 510 for the user, allowing the index to account for relationships between multiple emotions of the user for a received order.

The online concierge system 102 stores a score in the index association with a combination of an item and an emotion in various embodiments, with the score providing a measure of relationship between the item and the emotion. In various embodiments, the score for a combination of an item and an emotion is based on a number of received orders including the item for which the online concierge system 102 determined 510 the emotion for the user. For example, a score associated with a combination of item and emotion is a percentage of orders associated with the emotion received 505 from the user that include the item. In other examples, the score associated with the combination of item and emotion is generated from the percentage of orders associated with the emotion determined 510 for the user that include the item. When the online concierge system 102 stores contextual information with a received order as well as a determined emotion for the received order, the index associates a combination of the contextual information and the determined emotion in association with an item. In various embodiments, the online concierge system 102 determines a score for an item and a combination of an emotion and contextual information from a number of received orders including the item for which the online concierge system 102 determined 510 the emotion for the user and received the contextual information. For example, a score associated with an item and a combination of emotion and contextual information is based on a percentage of orders that include the item and that are associated with the emotion determined 510 for the user and with the contextual information. Hence, in various embodiments, the score for a combination of an item and an emotion reflects a rate at which the item was included in orders by the user when the emotion was determined 510 for the user.

Subsequently, when the online concierge system 102 receives 525 a request for an additional order from the user, the online concierge system 102 determines 530 an emotion of the user when the request was received from inputs received in conjunction with the request, as further described above. In various embodiments, the online concierge system 102 also receives contextual information about the user in conjunction with the request. From the emotion of the user when the request was received, and contextual information received along with the request, the online concierge system 102 identifies 535 candidate items for the user from the index stored in association with the user. The candidate items are items associated with the emotion of the user when the request was received, or associated with a combination of the emotion of the user when the request was received and the contextual information received in conjunction with the request, in the index. This allows the online concierge system 102 to leverage the emotion determined 530 for the user when the request for the additional order was received, as well as contextual information received in conjunction with the user, to identify candidate items for the user.

The online concierge system 102 selects 540 one or more of the candidate items for display to the user. For example, the online concierge system 102 ranks the candidate items based on their corresponding scores in the index and selects 540 one or more candidate items having at least a threshold position in the ranking for display. Such ranking allows the online concierge system 102 to select candidate items the user has most frequently included in orders when the emotion was determined for the user, as the score for a combination of an item and an emotion is based on a frequency with which the item was included in orders received 505 when the emotion was determined 510 for the user. Alternatively, the online concierge system 102 selects 540 candidate items having at least a threshold score or selects 540 a candidate item having a maximum score for the combination of candidate item and the emotion determined 530 for the user when the request was received. When the online concierge system 102 receives contextual information with the request, the online concierge system 102 selects 540 one or more candidate items associated with the contextual information and the emotion of the user when the request was received, allowing the candidate items to account for both contextual information when the request was received and the emotion determined 530 for the user when the request was received.

When selecting 540 one or more items for display to the user, the online concierge system 102 accounts for predicted availabilities of various candidate items at a warehouse 110 identified by the request for an order. In various embodiments, the online concierge system 102 applies a machine-learned availability model 216, further described above in conjunction with FIGS. 2 and 4, to each combination of warehouse 110 and candidate item. The online concierge system 102 selects 540 one or more candidate items based on their scores for the emotion determined 530 for the user when the request was received and the predicted availability of different candidate items. For example, the online concierge system 102 ranks the candidate items based on their corresponding scores in the index and modifies the ranking by removing candidate items having less than a threshold availability. The online concierge system 102 selects 540 one or more candidate items having at least a threshold position in the modified ranking. In other embodiments, the online concierge system 102 selects 540 one or more candidate items having at least a threshold score and having at least a threshold predicted availability.

In some embodiments, the online concierge system 102 selects 540 one or more candidate items based on scores of the candidate items for the emotion determined 530 for the user when the request was received 525 and contextual information received in conjunction with the request for the additional order. For example, contextual information identifies a location for the additional order, and the online concierge system 102 retrieves previously received orders identifying the location. From the previously received orders, the online concierge system 102 ranks items based on frequencies with which the items occur in the previously received orders identifying the location. The online concierge system 102 selects 540 one or more items included in previously received orders identifying the location and associated with the emotion determined 530 for the user when the request for the additional order was received. For example, the online concierge system 102 selects 540 items associated with the emotion determined 530 for the user when the request was received 525 having at least a threshold score for the emotion determined 530 for the user when the request was received 525 and included in previously received orders identifying the location.

As another example, the contextual information received in conjunction with the request for the additional order includes biometric information for the user. As further described above, the online concierge system 102 identifies 535 candidate items for the user from the index stored in association with the user. Each of the candidate items is associated with the emotion of the user when the request was received. The online concierge system 102 retrieves attributes of the candidate items from an item catalog or other source of stored attributes for items offered by the warehouse 110 and selects 540 one or more items of the candidate items by comparing one or more attributes of the items to the biometric information for the user. For example, the online concierge system 102 ranks candidate items by an attribute corresponding to the received biometric information for the user and compares the received biometric information to one or more threshold values. Based on the comparison of the biometric information for the user, the online concierge system 102 determines a position in the ranking from which an item is selected 540. As an example, the biometric information received in conjunction with the request for the additional order includes the user's blood sugar level, so the online concierge system 102 ranks candidate items based on their respective amounts of sugar. The online concierge system 102 compares the user's blood sugar level to a threshold and selects 540 an item from a range of positions in the ranking in response to the user's blood sugar level equaling or exceeding the threshold and selects 540 an item from an alternative range of positions in the ranking in response to the user's blood sugar level being less than the threshold. This allows the online concierge system 102 to leverage both the determined emotion for the user, as well as biometric information received for the user and attributes of items, to select 540 one or more items for display to the user, while accounting for both items the user has previously purchased having the determined emotion and potential effects of those previously purchased items on biometric information received for the user.

In various embodiments, the online concierge system 102 determines the emotion of the user, as well as contextual information, after receiving 525 the request for the additional order. When identifying 535 the candidate items and selecting 540 one or more of the candidate items, the online concierge system 102 accounts for changes in the emotion determined 530 for the user and contextual information from the user as the user interacts with the online concierge system 102. This allows the items selected 540 by the online concierge system 102 to reflect a most current emotion and most current contextual information as the user interacts with the online concierge system 102 when creating or generating the additional order.

The online concierge system 102 transmits 545 information identifying the one or more selected items to a client device (e.g., a mobile device, a desktop computer, a laptop computer, etc.) for display. In various embodiments, information identifying one or more selected items are displayed in a region of the customer mobile application 106. The information identifying one or more selected items are displayed in a region of the customer mobile interface 106 identifying items previously purchased by the user. Additionally, the interface displays a selection element in conjunction with information identifying each selected item that includes the selected item in the additional order when selected by the user.

In alternative embodiments, the online concierge system 102 maintains attributes corresponding to different emotions for different items. For the user, the online concierge system 102 leverages orders received 505 from the user and emotions determined 510 for the user when the corresponding orders were received to generate a score for combinations of an item included in a previously received order and an emotion. As further described above, the score for a combination of the item and an emotion is based on a number of received orders including the item for which the online concierge system 102 determined 510 the emotion for the user. For example, a score associated with a combination of item and emotion is a percentage of orders associated with the emotion received 505 from the user that include the item. In other examples the score associated with the combination of item and emotion is generated from the percentage of orders associated with the emotion received 505 from the user that include the item. The online concierge system 102 may average scores for combinations of item and emotion generated for various users and store the average score for an emotion as a value of the attribute corresponding to the emotion for the item. Hence, the online concierge system 102 may maintain an embedding for an item including the average score for different emotions determined for the item.

With embeddings derived from average scores for different emotions determined and stored for various items, the online concierge system 102 selects 540 one or more candidate items by determining an emotion embedding for the user from inputs received from the user in conjunction with the additional order. For example, the emotion embedding is based on probabilities of different emotions being determined 510 for the user. The online concierge system 102 determines measures of similarities between the emotion embedding for the user and embeddings for various items. Example measures of similarity include a cosine similarity between the emotion embedding and an embedding for an item, a dot product between the emotion embedding and the embedding for the item, a Euclidian distance between the emotion embedding and the embedding for the item, or any other suitable measure of similarity between embeddings. The online concierge system 102 selects 540 one or more candidate items based on the determined measures of similarity. For example, the online concierge system 102 selects 540 items with embeddings having at least a threshold measure of similarity to the emotion embedding. Alternatively, the online concierge system 102 ranks items based on their measures of similarity to the emotion embedding and selects 540 items having at least a threshold position in the ranking.

FIG. 6 is a process flow diagram of one embodiment of a method for an online concierge system 102 to recommend one or more items to a user based in part on an emotion inferred for the user. For purposes of illustration, FIG. 6 shows an index 605 an index generated for a user that correlates items 610A, 610B, 610C, 610D (also referred to individually and collectively using reference number 610) included in orders with determined emotions 615 of the user. As further described above in conjunction with FIG. 5 the online concierge system 102 determines an emotion for a user based on inputs received from the user in conjunction with an order and associates the determined emotion with the order. The emotion correlated with an item in the index 605 is based on a number of orders including the item received from the user and associated with the determined emotion 615. For purposes of illustration, FIG. 5 shows a single emotion 615 correlated with each item 610; however, in various embodiments, the online concierge system 102 stores correlations between an item 610 and multiple emotions 615, depending on emotions associated with orders including the item 610. For example, the online concierge system 102 correlates an emotion 615 with an item 610 in response to the emotion 615 being associated with at least at threshold number or a threshold percentage of orders received during a specific time interval or having at least a threshold rate of being included in orders during a specific time interval.

Additionally, the index 605 associates a score 620 with each combination of item 610 and its corresponding determined emotion 615. As further described above in conjunction with FIG. 5, the score 620 indicates a relationship between the item 610 and the emotion 615. For example, a score associated with a combination of item 610 and emotion 615 based on a percentage of orders associated with the emotion 615 and received from the user that include the item 610. The index 605 is stored in association with a user, allowing the index 606 to leverage prior orders received from the user and emotions determined for the user when the prior orders were received to determine an emotion determined for the user when the user purchased different items 610.

When the online concierge system 102 receives a request 625 for an order and inputs 630 from the user in conjunction with the request, the online concierge system 102 determines an emotion 635 for the user from the inputs 630. As further described above in conjunction with FIG. 5, the online concierge system 102 determines the emotion 635 of the user by applying one or more models to the inputs 630, such as audio or video data received in conjunction with the request 625 for the order. The online concierge system 102 retrieves the index 605 for the user and identifies candidate items 640 from the index 605 based on the emotion 635 determined for the user with the request 625. For example, the online concierge system 102 identifies candidate items 640 as items 610 included in the index 605 associated with an emotion 615 matching the emotion 635 determined for the user. In the example of FIG. 6, item 610B and item 610C are associated with an emotion 615 in the index 605 matching the emotion 635 of the user determined when the request 625 for the order was received, so the online concierge system 102 selects items 610B, 610C as candidate items 640. As further described above, the online concierge system 102 selects one or more of the candidate items 640 for display to the user. This allows the online concierge system 102 to leverage information about a determined emotion for the user for an order and emotions determined for the user for prior orders to select items to identify to the user that the user previously purchased when having the determined emotion. Such leveraging of a user's emotion when ordering allows the online concierge system 102 to more readily identify items likely to be of interest to the user when creating an order, reducing an amount of interaction by the user with the online concierge system 102 to identify and to include relevant items in an order.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online concierge system, orders from a user, each order including one or more items;
determining, by the online concierge system, an emotion of the user corresponding to each received order from input received from the user in conjunction with each received order;
storing, at the online concierge system, the emotion of the user corresponding with a received order in association with the corresponding received order;
generating an index correlating items included in received orders with the emotion of the user from items included in the received orders with emotions of the user, an emotion of the user correlated with an item based on the emotion of the user corresponding to an order that included the item;
receiving, at the online concierge system, a request for an additional order from the user;
determining an emotion of the user for the additional order from one or more inputs received with the request;
identifying one or more candidate items from the index based on the emotion of the user for the additional order, each candidate item correlated with the emotion of the user for the additional order; and
transmitting information describing one or more items selected from the one or more candidate items to a client device of a user for display in an interface.

2. The method of claim 1, wherein generating the index correlating items included in received orders with the emotion of the user from items included in the received orders with emotions of the user comprises:
determining items that were included in at least a threshold amount of received orders associated with an emotion of the user for the received orders;
storing an association in the index between each of the determined items and the emotion of the user for the received orders.

3. The method of claim 1, wherein generating the index correlating items included in received orders with the emotion of the user from items included in the received orders with emotions of the user comprises:
storing an association in the index between the item and an emotion of the user for one or more received orders including the item; and
storing a score in the index for a combination of the item and the emotion of the user for the one or more received orders including the item, the score based on a number of the one or more received orders including the item and associated with the emotion of the user for the one or more received orders.

4. The method of claim 3, wherein the score for the combination of the item and the emotion of the user for the one or more received orders including the item comprises a percentage of received orders that are associated with the emotion of the user for the one or more received orders and that included the item.

5. The method of claim 3, wherein transmitting information describing one or more items selected from the one or more candidate items to the client device of the user for display in the interface comprises:
selecting one or more candidate items having at least a threshold score; and
transmitting information describing the selected one or more candidate items to the client device of the user for display.

6. The method of claim 3, wherein transmitting information describing one or more items selected from the one or more candidate items to the client device of the user for display in the interface comprises:
ranking the one or more candidate items based on their scores;
selecting one or more candidate items having at least a threshold position in the ranking; and
transmitting information describing the selected one or more candidate items to the client device of the user for display.

7. The method of claim 3, wherein transmitting information describing one or more items selected from the one or more candidate items to the client device of the user for display in the interface comprises:
determining a predicted availability of each of the one or more candidate items at a warehouse identified by the request;
selecting one or more candidate items having at least a threshold predicted availability based on the scores; and
transmitting information describing the selected one or more candidate items to the client device of the user for display in the interface.

8. The method of claim 1, wherein generating the index correlating items included in received orders with the emotion of the user from items included in the received orders with emotions of the user comprises:
storing an association in the index between the item and a combination of an emotion of the user for one or more received orders including the item and contextual information received with the one or more received orders including the item

9. The method of claim 1, wherein receiving, at the online concierge system, the request for an additional order from the user comprises:
receiving, at the online concierge system, the request for the additional order and contextual information from the user.

10. The method of claim 9, wherein transmitting information describing one or more items selected from the one or more candidate items to the client device of a user for display in the interface comprises:
selecting one or more candidate items based on the emotion of the user for the additional order and the contextual information from the user.

11. The method of claim 10, wherein the contextual information from the user comprises biometric information of the user, and wherein transmitting information describing one or more items selected from the one or more candidate items to the client device of the user for display in the interface comprises:
selecting one or more candidate items correlated with the emotion of the user for the additional order by comparing one or more attributes of the candidate items to the biometric information for the user; and
transmitting information describing the selected one or more candidate items to the client device of the user for display in the interface.

12. The method of claim 10, wherein the contextual information from the user comprises a location for the additional order, and wherein transmitting information describing one or more items selected from the one or more candidate items to the client device of the user for display in the interface comprises:
selecting one or more candidate items correlated with the emotion of the user for the additional order based on frequencies with which the candidate items occur in previously received orders identifying the location; and
transmitting information describing the selected one or more candidate items to the client device of the user for display in the interface.

13. A computer program product comprising a non-transitory computer readable storage medium having instructions encoded thereon that, when executed by a processor, cause the processor to:
receive, at an online concierge system, orders from a user, each order including one or more items;
determine, by the online concierge system, an emotion of the user corresponding to each received order from input received from the user in conjunction with each received order;
store, at the online concierge system, the emotion of the user corresponding with a received order in association with the corresponding received order;
generate an index correlating items included in received orders with the emotion of the user from items included in the received orders with emotions of the user, an emotion of the user correlated with an item based on the emotion of the user corresponding to an order that included the item;
receive, at the online concierge system, a request for an additional order from the user;
determine an emotion of the user for the additional order from one or more inputs received with the request;
identify one or more candidate items from the index based on the emotion of the user for the additional order, each candidate item correlated with the emotion of the user for the additional order; and
transmit information describing one or more items selected from the one or more candidate items to a client device of a user for display in an interface.

14. The computer program product of claim 13, wherein generate the index correlating items included in received orders with the emotion of the user from items included in the received orders with emotions of the user comprises:
determine items that were included in at least a threshold amount of received orders associated with an emotion of the user for the received orders;
store an association in the index between each of the determined items and the emotion of the user for the received orders.

15. The computer program product of claim 13, wherein generate the index correlating items included in received orders with the emotion of the user from items included in the received orders with emotions of the user comprises:
store an association in the index between the item and an emotion of the user for one or more received orders including the item; and
store a score in the index for a combination of the item and the emotion of the user for the one or more received orders including the item, the score based on a number of the one or more received orders including the item and associated with the emotion of the user for the one or more received orders.

16. The computer program product of claim 15, wherein the score for the combination of the item and the emotion of the user for the one or more received orders including the item comprises a percentage of received orders that are associated with the emotion of the user for the one or more received orders and that included the item.

17. The computer program product of claim 15, wherein transmit information describing one or more items selected from the one or more candidate items to the client device of the user for display in the interface comprises:
select one or more candidate items having at least a threshold score; and
transmit information describing the selected one or more candidate items to the client device of the user for display.

18. The computer program product of claim 15, wherein transmit information describing one or more items selected from the one or more candidate items to the client device of the user for display in the interface comprises:
rank the one or more candidate items based on their scores;
select one or more candidate items having at least a threshold position in the ranking; and
transmit information describing the selected one or more candidate items to the client device of the user for display.

19. The computer program product of claim 15, wherein transmit information describing one or more items selected from the one or more candidate items to the client device of the user for display in the interface comprises:
determine a predicted availability of each of the one or more candidate items at a warehouse identified by the request;
select one or more candidate items having at least a threshold predicted availability based on the scores; and
transmit information describing the selected one or more candidate items to the client device of the user for display in the interface.

20. The computer program product of claim 13, wherein generate the index correlating items included in received orders with the emotion of the user from items included in the received orders with emotions of the user comprises:
store an association in the index between the item and a combination of an emotion of the user for one or more received orders including the item and contextual information received with the one or more received orders including the item

21. The computer program product of claim 13, wherein receive, at the online concierge system, the request for the additional order from the user comprises:
receive, at the online concierge system, the request for the additional order and contextual information from the user.

22. The computer program product of claim 21, wherein transmit information describing one or more items selected from the one or more candidate items to the client device of a user for display in the interface comprises:
select one or more candidate items based on the emotion of the user for the additional order and the contextual information from the user.

23. The computer program product of claim 22, wherein the contextual information from the user comprises biometric information of the user, and wherein transmit information describing one or more items selected from the one or more candidate items to the client device of the user for display in the interface comprises:
select one or more candidate items correlated with the emotion of the user for the additional order by comparing one or more attributes of the candidate items to the biometric information for the user; and
transmit information describing the selected one or more candidate items to the client device of the user for display in the interface.

24. The computer program product of claim 22, wherein the contextual information from the user comprises a location for the additional order, and wherein transmit information describing one or more items selected from the one or more candidate items to the client device of the user for display in the interface comprises:
select one or more candidate items correlated with the emotion of the user for the additional order based on frequencies with which the candidate items occur in previously received orders identifying the location; and
transmit information describing the selected one or more candidate items to the client device of the user for display in the interface.
